(19) United States
(12) Patent Application Publication
(10) Pub. No.: US 2006/0003652 A1
(43) Pub. Date: Jan. 5, 2006

(54) Waterproofing membrane and methods of use

(76) Inventor: Denis Faucher, Chateau-Richer (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/159,236

(22) Filed: Jun. 23, 2005

Related U.S. Application Data
(63) Continuation-in-part of application No. 09/933,798, filed on Aug. 22, 2001.
(63) Continuation-in-part of application No. 10/486,838, filed on Nov. 16, 2004.
(63) Continuation-in-part of application No. 10/338,857, filed on Jan. 9, 2003, now abandoned.

(51) Int. Cl. B32B 27/04; B32B 27/12; B32B 5/02; B31B 1/60; B32B 25/10; B32B 11/06

(52) U.S. Cl. 442/86; 442/286; 442/295; 442/298; 442/394; 442/399; 442/412; 428/489; 428/490; 428/491; 52/408; 156/60

(57) ABSTRACT

A waterproofing membrane and uses for it. The membrane has a layer of bitumen based material on a sheet of support material, and preferably has a protective layer on the bituminous material to allow the membrane to be easily unrolled if it is shipped in a roll. It is to be installed to a surface by an adhesive coating and can be provided adhered to a board to form a waterproofing panel. The membrane can be used as an adhesive to apply a decorative facade on a wall in addition to being used for sole waterproofing purposes. The decorative facade is applied subsequently to heating the membrane, which volatilizes the protective layer and softens the bituminous layer. To increase the adhesiveness of the membrane, a tackifier such as styrene-isoprene-styrene is blended into the bituminous layer.

### CROSS-REFERENCE TO RELATED APPLICATIONS

This application is a continuation-in-part of U.S. patent application Ser. No. 09/933,798 filed Aug. 22, 2001, Ser. No. 10/338,857 filed Jan. 9, 2003, and Ser. No. 10/486,838 filed Nov. 16, 2004, the specifications of which are hereby incorporated by reference, all of which are now pending.

### BACKGROUND OF THE INVENTION

1) Field of the Invention

The invention relates to materials used in the field of construction and renovation. More particularly, the invention presents a waterproofing membrane and its uses.

2) Description of the Prior Art

Waterproofing membranes are common in the art of roof waterproofing. Known waterproofing membranes are typically provided with a layer of bitumen which may be modified by styrene-butadiene-styrene (SBS), and which is covered on one or both sides with peel-off sheets. The peel-off sheets prevent the successive layers of the membrane from adhering to one another when it is rolled-up for distribution purposes. At the time of installation of the membrane however, the peel-off sheet or sheets must be removed and this operation is found quite cumbersome by installation workers. Prior art waterproofing membranes are typically provided with an embedded reinforcement sheet layer that gives additional tearing resistance to the membrane. The reinforcement sheet is incorporated into the body of the membrane by dipping it into a molten bath of bituminous composition during the manufacture, and it is thus sandwiched within bitumen on both sides.

Bitumen has somewhat inherent adhesive characteristics which can be stimulated by heating. Therefore, known waterproofing membranes are generally applied either by heating with torches, which softens the bituminous layer and allows it to adhere to the rooftop, or by application of hot air-blown asphalt which acts as an adhesive between the membrane and the rooftop. While bituminous membranes modified with styrene-butadiene-styrene (SBS) can be applied with both methods, application with the air-blown bitumen method yields better results because they tend to become excessively softened when submitted to heat, especially in summer. However, the air-blown asphalt method generates strong odors which are found repulsive by workers and the nearby public. There thus remains a need for a waterproofing membrane which would be easier to install while retaining the advantage of being package able for shipment.

In another aspect, in building construction, air leakage can account for an important percentage of the total heat loss in homes because warm air leaks out while cold air leaks in. Along with the air, moisture (vapor) escapes and can condense inside the walls or attic and could cause serious structural damage when mold, mildew and rot occurs. For example, showers in bathrooms are often especially susceptible since the humidity content of the air inside regularly reaches high levels. A good seal in the walls of a shower is desired.

To avoid air and vapor transfers, builders use products to create an air/vapor barrier envelope. The most important property of an air-vapor barrier is the ability to resist airflow and air pressure. A continuous air/vapor barrier completely encloses air within a building, keeping water vapor from entering insulated cavities where it can condense. Vapor retardants inhibit vapor diffusion, but remain partially permeable to air and humidity. Bitumen-based layers are often applied to masonry or sheathing material to create air and vapor barriers. The users of membranes currently face problems when applying such membranes to vertical surfaces, because relatively complex steps are required to achieve robust adherence. Of course, if an effective seal is not attained, the membrane system will leak and not achieve its very purpose. A need is thus felt to improve the means to install such barriers on vertical surfaces.

Now turning to still another aspect, it is know in the field of tile application that many good adhesives need to used at controlled atmospheres, often at 20° C. This is also the case for application of masonry products. This is a problem in applications where a controlled atmosphere is difficult to attain. Refrigerators must sometimes be stopped for several days to change tiles, which causes the loss of profits. A need is strongly felt for an adhesive which may be applied at a wider range of temperatures.

Now turning to yet another aspect, it is know in the field of construction to provide synthetic bricks that are adhered to the walls of buildings to provide an appealing facing. The known systems to adhere synthetic bricks to the vertical surfaces of walls of buildings require many layers in order to provide a durable construction that will last with time and changing weather. A need is thus felt for a system that will make brick surfaces easier to install.

### SUMMARY OF THE INVENTION

An object of the invention is to provide a membrane which addresses at least some of the inconveniences of the prior art.

An object of the invention is to provide a membrane that can be applied with an adhesive coating without the need of a peel-off sheet.

An object of the invention is to provide a waterproofing membrane which can be applied to a vertical surface more easily than the prior art membranes.

Another object of the invention is to provide a waterproofing membrane that can serve as an adhesive for the purpose of mounting a brick, stone or tile facade.

In accordance with one aspect, the invention provides a waterproofing membrane to be applied on a surface. The waterproofing membrane comprises a bituminous layer of bitumen based waterproofing material having opposite first and second sides and having a thickness of from 0.5 mm to 4 mm; a protective layer of impervious surfacing material directly adhered to said first side of the bituminous layer; a support sheet layer made of a porous material and having a first and second surface with the first surface directly adhered to the second side of the bituminous layer by means of the waterproofing material transuding partially into the pores of the support sheet; and an adhesive coating to be partially transuded into the pores of the support sheet and to be adhered to the surface.

In accordance with another aspect, the invention provides a method of waterproofing comprising the steps of: providing a support sheet layer, the support sheet layer made of a porous material and having a first and second surface; heating and applying a bituminous layer of bitumen based waterproofing material to the first surface of the support sheet so that the resulting bituminous layer has a thickness of from 0.5 mm to 4 mm, and an exposed side; adhering a protective layer of impervious surfacing material directly to said exposed side of the bituminous layer, the protective layer, bituminous layer and support sheet layer forming a waterproofing membrane; applying an adhesive coating to at least one of a support surface and the second surface of the support sheet; and adhering the second surface of the support sheet layer to the support surface by the adhesive coating.

In accordance with still another aspect, the invention provides a method of adhering appliqués to a membrane having a bituminous layer of bitumen based waterproofing material, the method comprising the steps of: softening a selected portion of the bituminous layer by heating; and applying the appliqué against the selected softened portion of the bituminous layer.

### BRIEF DESCRIPTION OF THE DRAWINGS

Further features and advantages of the present invention will become apparent from the following detailed description, taken in combination with the appended drawings, in which:

FIG. 1A is a perspective view of a waterproofing membrane in accordance with one embodiment of the invention, shown applied to a horizontal surface.

FIG. 1B is a cross-sectional view of the waterproofing membrane of FIG. 1A.

FIG. 2 is a perspective view of the waterproofing membrane of FIG. 1, shown in rolled up configuration.

FIG. 3 is a perspective view of the waterproofing membrane of FIG. 1, shown applied on a board and forming a waterproofing panel.

FIG. 4 is a perspective view showing workers installing a facade of decorative bricks using the waterproofing panel of FIG. 3.

FIG. 5 is an enlarged, perspective view of the waterproofing panel of FIG. 4 secured to a frame.

FIG. 6 is a perspective view, partly sectioned, showing a typical wall construction realized using the waterproofing panel of FIG. 3.

FIG. 7 includes FIG. 7A, 7B, 7C and 7D, which illustrate a decorative brick in accordance with an other embodiment of the invention in different steps of preparation.

It will be noted that throughout the appended drawings, like features are identified by like reference numerals.

### DETAILED DESCRIPTION OF THE PREFERRED EMBODIMENT

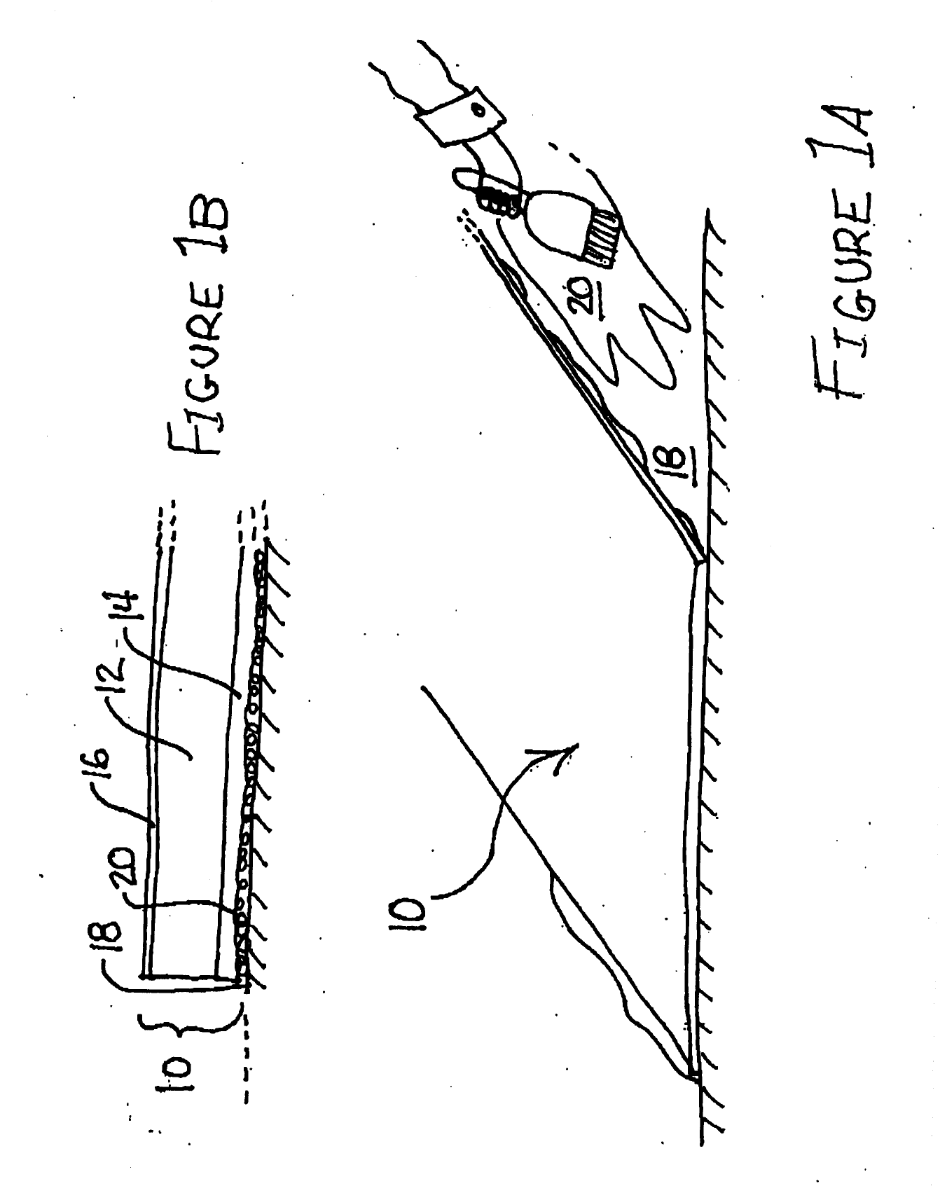

Referring to FIGS. 1A and 1B, a waterproofing membrane 10 in accordance with one embodiment of the invention is shown applied to a horizontal rooftop 18. The waterproofing membrane 10 includes a layer 12 of bitumen based waterproofing material referred to as the bituminous layer 12 which is bonded to a layer of kraft paper 14 by being partially penetrated into the pores thereof. The membrane 10 further includes a polyethylene film 16 covering the face of the bitumen layer 12 which is opposite to the kraft paper 14 and which would be exposed otherwise. The bitumen layer 12 is thus sandwiched between the polyethylene film 16 and the sheet of kraft paper 14. The waterproofing membrane 10 is applied to the rooftop 18 by means of a coating 20 of wall-paper glue which is applied to the rooftop 18 by workers. The exposed face of the kraft paper layer 14 is then applied onto the coating 20, to which it adheres. In its preferred mode of manufacture, the bituminous layer 12 is 1 mm thick, the kraft paper 14 has the thickness of a sheet of paper, and the polyethylene film 16 is less than 2 μm thick. The membrane 10 can have a width ranging from 24 to 60 inches.

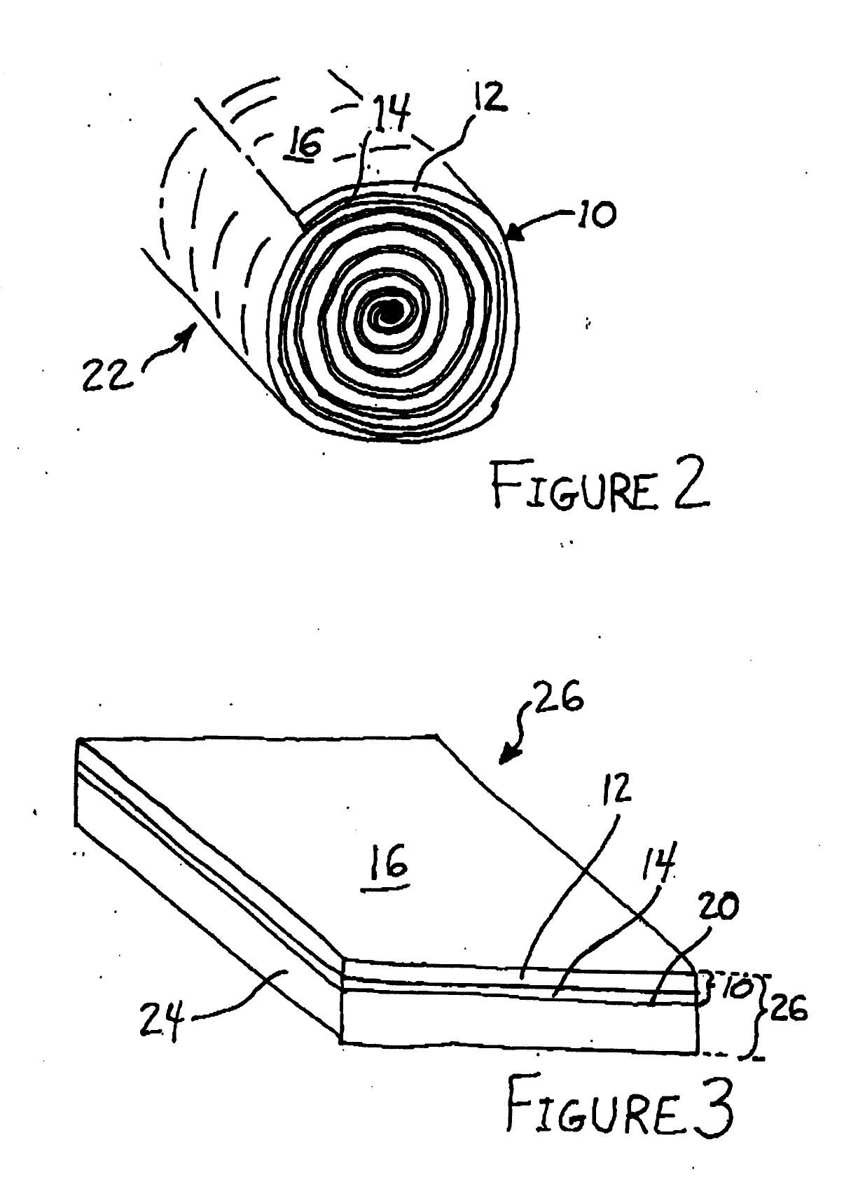

Turning now to FIG. 2, the membrane 10 is shown rolled up into a roll 22, for shipping purposes. Successive layers of the membrane 10 overlap one around the other, and the only contact is between the kraft paper 14 and the polyethylene film 16 of successive layers. The roll can thus easily be unrolled by the workers during installation without sticking, and therefore without requiring an additional peel-off sheet.

The bituminous layer 12 is made of between 50 and 100% by weight of bitumen which can be mixed with polymers, among others. Bitumen has the property of being waterproof and exposes an certain amount of inherent adhesiveness. Different types of bitumen exist, bitumen which have a penetration number comprised between 60 to 220 dmm and a softening point comprised between 70° C. and 140° C. are preferably used for modification with polymers. It is furthermore possible to use mixture of various types of bitumen, and the properties of the bitumen can be modified by adding mineral oils, fatty substances, chemical agents which make it impenetrable to roots, and others. The preferred bitumen is Type III oxidized bitumen, available from Shell.

The ratios of polymers used in preparing a bitumen mixture may vary depending of the physical and chemical properties needed. In a waterproofing membrane, for example, the bituminous layer 12 may comprise between 5 to 15% by weight of copolymers, which can be, for example, a mixture of between 25 to 70% propylene, 20 to 70% butene and 0 to 15% ethylene.

Instead, or in combination with a polymer, a filler can be blended into the bituminous mixture. The types of fillers commonly used are various, among them are included slate powder, calcium carbonate, talc, kaolin and other compounds which are well-known in the art. The usual purpose of the filler is to increase the stability of the mixture. Preferably, the filler used may have such a fineness as to pass through a 75-micron screen, although fillers which pass to an extent through a 60-micron (200-mesh) screen may also be used.

The membrane 10 can be used as an adhesive instead of being used only for its waterproofing characteristics, in which case the use of fillers is preferably avoided. The bituminous layer can be softened by heating which increases its adhesiveness, and it then returns gradually to its firmer state as the heat dissipates. The adhesiveness characteristics of the bituminous layer 12 can be increased substantially by adding a “tackifier” blended in with bitumen. The adhesiveness of the bituminous layer 12 can be evaluated by the quantity of pounds per square foot that can be applied to an adhered decorative brick 32 before the brick 32 is pulled apart from the surface. The best results were achieved using styrene-isoprene-styrene (known as SIS) in a concentration of 5% to 30%, preferably 12 to 18%, and most preferably 15% by weight, homogeneously blended into a bituminous layer of 1 mm thickness, as the tackifier, which resulted in adhesion characteristics of over 12 pounds per square foot. SBS (Styrene-Butadiene-Styrene) may also be used, especially in applications where the adhesiveness of the membrane is not a priority. Alternative tackifiers selected to enhance the adhesive characteristics of the membrane should both generate desired adhesion characteristics in the membrane 10, and be compatible with bitumen.

The thickness of the bituminous layer is between 0.5 and 4 mm, but preferably 1.0 to 1.5 mm. If it is too thin however, it does not provide desirable adhesiveness and adaptability to the slightly rugged surfaces of decorative bricks 32. If it is too thick, it becomes overly cumbersome and loses some resistance to shearing forces.

The kraft paper 14 acts as a support sheet to the bituminous layer 12, and is preferably chosen between 0.2 and 0.3 mm thickness and of a density of between 36 and 44 pounds per cubic foot. Its function is to provide tearing resistance to the membrane 10 and to facilitate the adherence of the membrane to a surface using the adhesive coating 20. The preferred process to combine the bituminous layer 12 and the kraft paper 14 includes applying molten bitumen mixture onto the kraft paper 14. The kraft paper 14 is sufficiently porous to allow partial penetration or transuding of the molten bitumen into its pores, and yet sufficiently resistant to provide the desired tearing resistance to the membrane 10. Alternative support sheets can be used but should preferably have similar porosity and tearing resistance to maintain the desired characteristics. Suitable alternatives could be other types of paper, fabrics, fiber matrix, or mixtures of these.

The polyethylene film 16 can be referred to as the protective layer. Although this layer is optional, its use is advantageous because it impedes adhesion of the waterproofing layer that would otherwise be exposed and therefore provides for shipping the membrane as a roll or as stacked panels. In applications where the membrane is used as an adhesive, the use of a thin film (less than 20 μm) of low-density polyethylene as the protective layer is useful because it will go up in smoke when the membrane is heated, thus exposing the softened bituminous layer, and will not affect the adhesive characteristics of the membrane. Other types of protective layers having similar characteristics can be substituted to the polyethylene film 16, and should be thin and of low density. The polyethylene film can be applied onto the softened bitumen layer, or after it has hardened, and will typically adhere to it either way.

In applications where the membrane 10 is used solely for its waterproofing characteristics, it is not necessary for the protective layer 16 to be burnable by the heat since the membrane 10 is typically not heated. The array of permissible substitutes is thus substantially increased. For example, a sheet of metal can be used and further protect the bituminous layer 12 from UV light once the membrane is installed on a roof, for example.

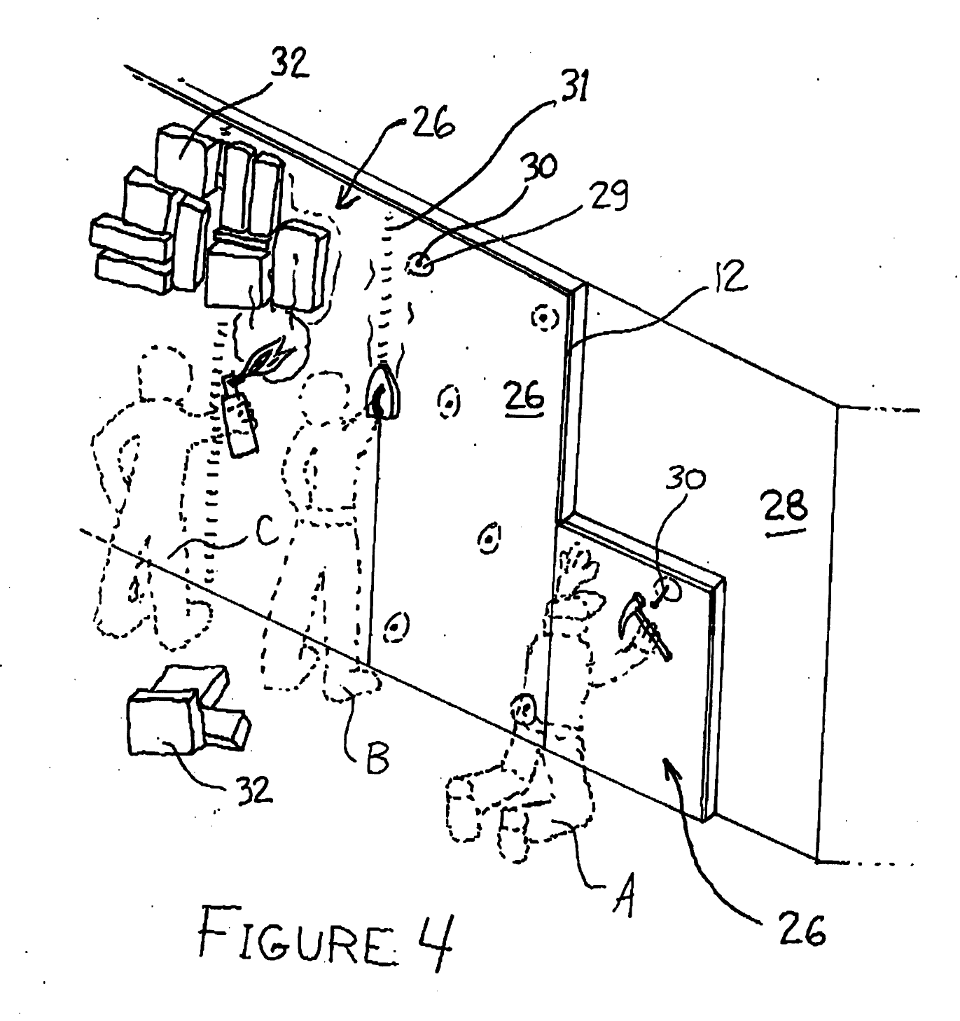

The surface 18 on which the membrane 10 is applied can be a wall, a roof, a board, or any other suitable surface. The adhesive coating 20 that is used to secure the support sheet 14 to the surface 18 can be adapted to the specific use of the membrane 10. Wall-paper glue has been found quite useful to install the membrane 10 directly on a wall, but alternative adhesive coatings such as that formed by a two-sided adhesive film or a contact adhesive can be used. However, to apply the membrane 10 to a vertical surface, it is preferred to provide it on a board 24 (see FIG. 3), as a waterproofing panel 26, and to then fasten the panel 26 to the vertical structure. In such applications, the membrane 10 will generally be applied to the board 24 inside a factory, and the adhesive chosen to bond the membrane 10 to the board 24 can thus be adapted to the specific conditions at which it is applied. The preferred type of adhesive for this use is the Super 77™ aerosol adhesive from 3M which includes cyclohexane (110-82-7), methyl pentane (107-83-5, 96-14-0), isobutene (75-28-5), dymethyl ether (115-10-6) and dimethyl butane (79-29-8, 75-83-2). The choice of the adhesive coating 20 is of higher importance in applications where the membrane 10 is used for its adhesive characteristics, in which the adhesive coating 20 used must resist the additional weight applied to it by the adhered materials and resist the heat used to soften the bituminous layer 12. Typically, the adhesive coating 20 will penetrate into the pores of the kraft paper 14 opposite to the bituminous layer 12, and will provide secure bonding to the surface.

The board 24 on which the membrane 10 is preferably provided can be of any suitable material, like a wood fiber board, a gypsum board, a perlite™ board, an insulating board or a board of plywood. When using the panel 26 in or against an external wall, it is advantageous to use an insulating board, made of an insulating material such as polystyrene, because the waterproofing panel then provides all three of waterproofing, insulating and adhesive characteristics at once and can be applied by a worker in a single step of fastening.

Turning to FIG. 3, the membrane 10 is shown applied to a board 24, and forms a waterproofing panel 26. This form is particularly useful when it is desired to apply the membrane 10 to a vertical surface, like a wall. The waterproofing panels 26 can be stacked one on top of each other for shipping, and are easily released from one another at installation because the polyethylene film 16 which prevents the back of the panels from adhering to the bituminous layer 12 of adjacent panels. Alternatively, the membrane could be provided without the polyethylene film 16, in which case an anti-adhesive sheet should be used between successive panels when stacking, but this is not preferred.

Turning now to FIG. 4, workers are shown proceeding to the installation of waterproofing panels 26 on a vertical wall. A worker ‘A’ places the exposed face of the board 24 of the waterproofing panel 26 against the structure 28, and inserts successive nails 30 through the panel 26 and into the structure 28 until the panel 26 is secured. The property of the bituminous layer is such that it tend to close in on the nail and keep water from seeping in around it. When fastening a waterproofing panel made with a board of insulating material, thin plastic washers 29 are placed upon the panel before nailing, to keep the head of the fasteners from penetrating into the panel. Although nails are preferred, one skilled in the art will realize that any suitable alternative fasteners can be used instead of nails, like staples or screws for example.

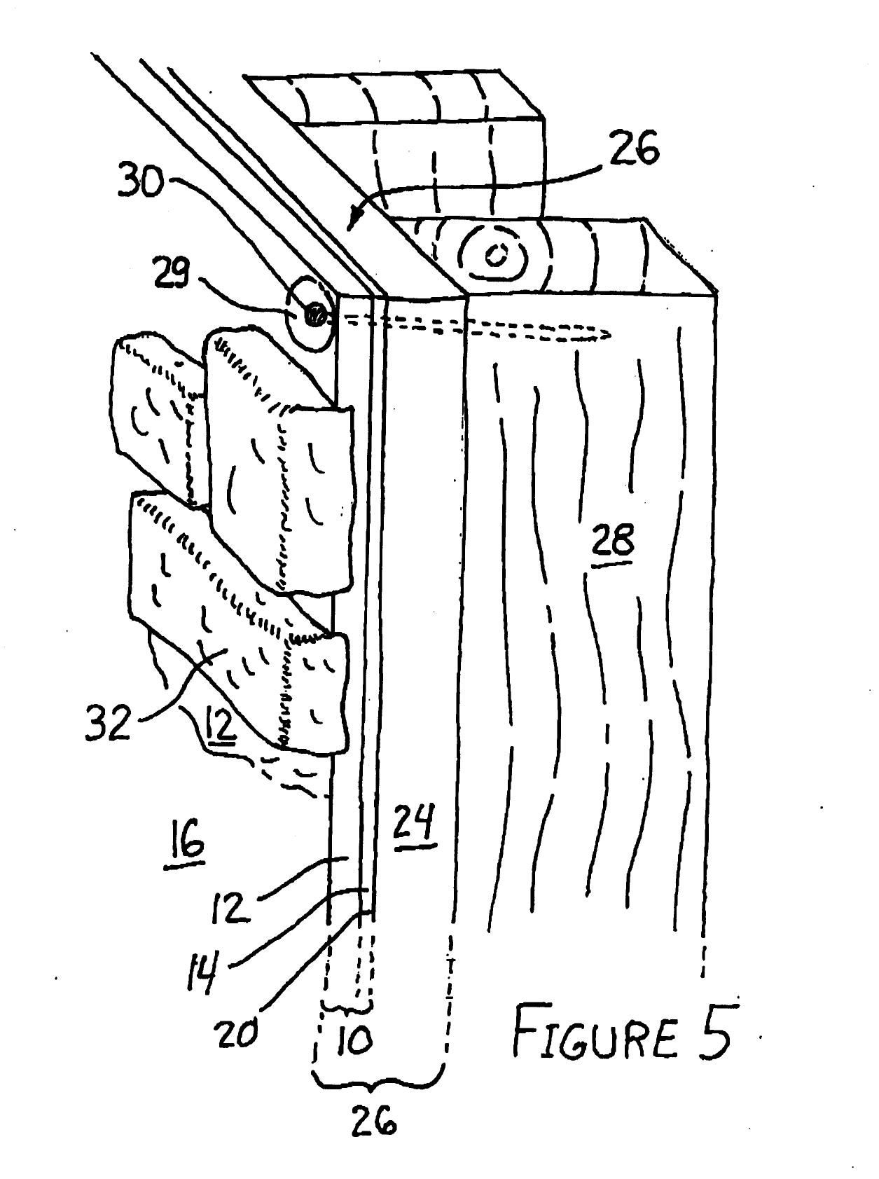

Still referring to FIG. 4, a worker ‘B’ is shown heating the joint between adjacent panels for the bituminous layers to fuse together and form a seal 31. A worker ‘C’ is shown heating the exposed surface of the waterproofing panel 26 to soften the bituminous layer 12. During this operation, the polyethylene film 16, if used, is consumed by the heat and goes up in smoke. The temperature of the bituminous layer 12 should be increased until close to or above its softening temperature, which is above 70° C. and typically around 100° to 140° C., to achieve a satisfying softening. Once the bituminous layer 12 is softened, a decorative brick 32 is applied onto the softened area and is adhered to the wall by the waterproofing membrane. FIG. 5 depicts in more detail how the panel 26 is held against a 2×4 wooden frame 28 by a nail 30 traversing it, and also shows in more detail how the bricks 32 are held within the bituminous layer 12.

Advantageously, when waterproofing panels 26 are disposed side by side, a bond in the bituminous layers 12 of the successive panels 26 can be achieved simply by heating the junction between the panels 26 with a metal plate to form a continuous seal 31. This is important when creating air-vapor barriers. The softened bituminous layer 12 of one panel 26 then fuses with the softened bituminous layer 12 of the adjacent panel. When fasteners 30 are applied, they typically generate heat during penetration, this heat will contribute to softening the bituminous layer 12 and maintaining an impervious seal around the fasteners 30. In applications where the waterproofing membranes 10 are used without boards, they can be overlapped and heated to adhere to one another at the juncture portion, or a tape made of the waterproofing membrane 10 can be applied in an overlapping manner between two membranes 10 or panels 26 onto a portion of heat-softened bitumen.

With reference to FIGS. 4 and 5, the use of the membrane 10 as an adhesive was illustrated with reference to applying decorative bricks 32 to the facade of a wall. One skilled in the art will realize that the membrane 10 can be used for adhering many other types of materials, which will be referred to generically as ‘appliqués’. The preferred use of the membrane 10 for its adhesive characteristics is to secure an appealing brick or stone facade to an exterior wall of a home by application of the successive decorative bricks or stones 32 to heated portions of the membrane. This can be realized by an ordinary workman which needs not to be a mason and can be achieved in adverse atmospheric conditions. In alternative applications, the appliqué can be tiles with the membrane used for bathroom walls and floors, or a gypsum, insulation, or wood board applied on the waterproofing panel, for example. The appliqué should be as light as possible, and the weight distribution of the appliqué should not exceed 20 lbs per square foot of adhesion surface, and preferably not exceed 12 lbs per square foot of adhesion surface.

The best adhesion characteristics of the membrane were obtained when the surface of the appliqué, which is adhered to the membrane, is smooth and porous to create a strong bond with the bitumen. Decorative bricks 32 are preferably made by cutting bricks in two along their length, which is illustrated in FIG. 7A and FIG. 7B. The rugged inside surface can further be treated by application of bitumen pellets 36 adhered on to it thereafter, as illustrated in FIG. 7C. When the decorative brick 32 thus created is applied to the heated bituminous layer 12, the bitumen pellets 36 will tend to fuse with the heated bituminous layer 12, especially if it is also heated, and the adhesiveness of the decorative brick 32 to the membrane 10 or panel 26 will be enhanced. Preferably, the pellets 36 are between 0.5 to 1 mm long.

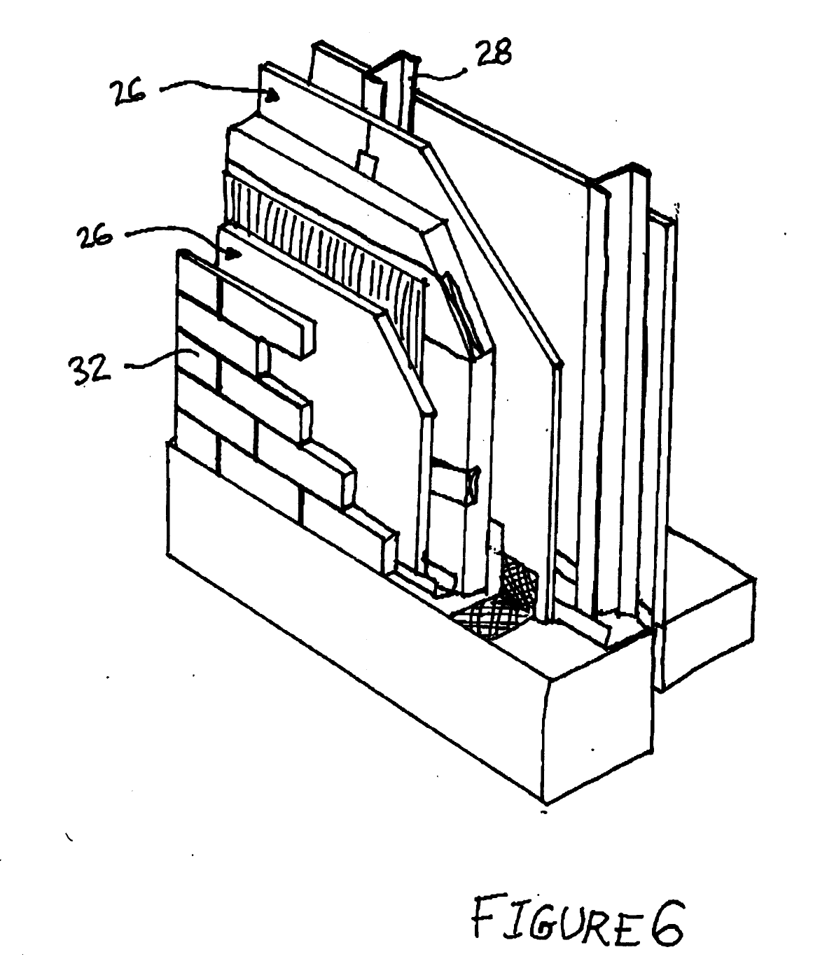

The decorative bricks 32 are preferably, sequentially installed one by one by successively heating a portion of the membrane to soften the bituminous layer 12, and applying the decorative bricks 32 against the softened portion with slight pressure. Mortar can be added between the bricks 32, on the bituminous layer 12, to achieve a natural finish. Once a brick 32 is installed, a seal can be created above it by heating: the area above the brick 32 for the bituminous layer 12 to slowly liquefy, and an accumulation of the bituminous composition dams up on the top edge of the brick nearest to the membrane 10. Water is thus kept from seeping in behind the brick 32 through sealing imperfections. Turning now to FIG. 6, an advantageous construction realized using waterproofing panels 26 in accordance with the invention is shown. A waterproof and insulated wall with a decorative facade is realized upon a metal frame.

The embodiment(s) of the invention described above is (are) intended to be exemplary only. The scope of the invention is therefore intended to be limited solely by the scope of the appended claims.

What is claimed is:

1. A waterproofing membrane to be applied on a surface comprising a bituminous layer of bitumen based waterproofing material having opposite first and second sides and having a thickness of from 0.5 mm to 4 mm; a protective layer of impervious surfacing material directly adhered to said first side of the bituminous layer; a support sheet layer made of a porous material and having a first and second surface with the first surface directly adhered to the second side of the bituminous layer by means of the waterproofing material transuding partially into the pores of the support sheet; and an adhesive coating to be partially transuded into the pores of the support sheet and to be adhered to the surface.

2. The membrane as defined in claim 1 wherein the surface is a board and forms a transportable waterproofing panel with the membrane adhered to the board.

3. The waterproofing membrane of claim 1 wherein the bituminous layer has at least 50% by weight of bitumen, and further comprises between 5 and 30% by weight of a homogeneously blended tackifier, and wherein the bitumen based material has a softening temperature above 70 degrees C.

4. The waterproofing membrane of claim 3 wherein the tackifier is styrene-isoprene-styrene (SIS) and constitutes between 12 and 18% by weight of the bitumen based material.

5. The waterproofing membrane of claim 3 further comprising an appliqué to be adhered to the membrane by a surface of the appliqué being applied to a portion of the bituminous layer previously softened by heating, and wherein the protective layer is adapted to volatilize when submitted to said heating.

6. The waterproof membrane and board combination as defined in claim 5 wherein the appliqué is selected from brick, stone, ceramic tile, a board, and an insulating material, and has less than 20 pounds per square foot of surface to be adhered.

7. The waterproofing membrane of claim 1 further comprising an appliqué having a surface thereof adapted to be adhered to the membrane by being applied to a portion of the bituminous layer previously softened by heating; wherein the protective layer is adapted to volatilize when submitted to said heating, and the appliqué has less than 20 pounds per square foot of surface to be adhered.

8. The waterproofing membrane of claim 1 wherein the support sheet is composed of fiber, said fiber comprising at least one of a paper, a fabric, and mixtures thereof.

9. The waterproofing membrane of claim 8 wherein the support sheet is a sheet of kraft paper having between 0.2 to 0.3 mm thickness and a density between 36 and 44 pounds per cubic foot.

10. The waterproofing membrane of claim 1 wherein the adhesive coating is one of wall-paper glue and a mixture including cyclohexane, methyl pentanes, isobutene, dimethyl ether, and dimethyl butane.

11. The waterproofing membrane of claim 1 wherein the protective layer is adapted to volatilize when heat to soften the bitumen-based material is applied to the protective layer.

12. The waterproofing membrane of claim 11 wherein the protective layer is a film of polyethylene having less than 20 microns thick.

13. The waterproofing membrane of claim 1, wherein said waterproofing material is a homogeneous blend having between 50 to 100% of bitumen, and up to 50% by weight of at least one copolymer, wherein combination of said bitumen and said copolymer forms 100% of said waterproofing material, and said copolymer is one of styrene-butadiene-styrene, ethylene, propylene, butene, a derivative and a mixture thereof.

14. The waterproofing membrane of claim 1 wherein the bituminous layer further comprises up to 40% by weight of a filler homogeneously blended in, the filler being selected from the group comprising slate powder, calcium carbonate, talc, and kaolin, the filler having the characteristic of passing through a 60 micron screen.

15. The waterproofing membrane and board combination as defined in claim 2 wherein the board is one of a perlite board, a gypsum board, a board of insulating material, concrete, and a wood-based board.

16. The waterproofing membrane and board combination as defined in claim 2 wherein the bituminous layer further comprises between 12 and 18% by weight of styrene-isoprene-styrene homogeneously blended in with the bitumen; the protective layer is a film of low-density polypropylene having less than 20 um thick and the support sheet is kraft paper.

17. The waterproofing membrane and board combination as defined in claim 16 wherein the waterproofing panel is secured to a vertical structure, the bitumen-based material has a softening temperature between 70 degrees C. and 140 degrees C.; further comprising at least one appliqué having a surface to be adhered to a previously softened portion of the bituminous layer in a manner to define a facade, wherein the at least one appliqué has less than 20 pounds per square foot of said surface to be adhered, and the surface to be adhered is flat and porous.

18. A method of waterproofing comprising the steps of:
providing a support sheet layer, the support sheet layer made of a porous material and having a first and second surface;
heating and applying a bituminous layer of bitumen based waterproofing material to the first surface of the support sheet so that the resulting bituminous layer has a thickness of from 0.5 mm to 4 mm, and an exposed side;
adhering a protective layer of impervious surfacing material directly to said exposed side of the bituminous layer, the protective layer, bituminous layer and support sheet layer forming a waterproofing membrane;
applying an adhesive coating to at least one of a support surface and the second surface of the support sheet; and
adhering the second surface of the support sheet layer to the support surface by the adhesive coating.

19. The method of waterproofing of claim 18 wherein the support surface is a board and forms a transportable waterproofing panel with the waterproofing membrane adhered to the board, further comprising the step of fastening the waterproofing panel to a structure in a vertical orientation and in a manner to maintain the waterproofing characteristics of the panel.

20. The method of claim 19 further comprising the steps of: fastening a second waterproofing panel adjacent the first panel; and fusing the adjacent portion of bituminous layers of the adjacent panels together by heat; whereby waterproofing is provided between the adjacent panels by the step of fusing.

21. A method of adhering appliqués to a membrane having a bituminous layer of bitumen based waterproofing material, the method comprising the steps of:
softening a selected portion of the bituminous layer by heating; and
applying the appliqué against the selected softened portion of the bituminous layer.

22. The method of claim 21, wherein the membrane is inclined between 60 and 90 degrees relatively to a horizontal plane, further comprising the steps of: subsequent to the step of applying, further softening a portion of the bituminous layer directly above the appliqué until a quantity of bitumen dams up against an upper surface of the appliqué, to seal the face of the appliqué which is against the bituminous layer.

23. The method of claim 21 wherein the steps of softening and applying are repeated on different portions of the bituminous layer until the membrane is substantially covered of appliqués, thus defining a facade; further comprising the step of applying mortar between appliqués to give the facade a natural appearance.
